(19) United States
(12) Patent Application Publication
(10) Pub. No.: US 2023/0180079 A1
(43) Pub. Date: Jun. 8, 2023

(54) METHOD FOR PERFORMING MEASUREMENTS FOR CELL RESELECTION

(71) Applicant: LG ELECTRONICS INC., Seoul (KR)

(72) Inventors: Jinyup HWANG, Seoul (KR); Yoonoh YANG, Seoul (KR); Sangwook LEE, Seoul (KR); Suhwan LIM, Seoul (KR); Jongkeun PARK, Seoul (KR); Jinwoong PARK, Seoul (KR)

(21) Appl. No.: 17/921,909

(22) PCT Filed: May 12, 2021
(86) PCT No.: PCT/KR2021/005935

§ 371 Date: Oct. 27, 2022

(30) Foreign Application Priority Data
May 13, 2020 (KR) 10-2020-0056980

(51) Int. Cl. H04W 36/00

(52) U.S. Cl. CPC H04W 36/0085

(57) ABSTRACT

One disclosure of the present specification provides a method by which a user equipment (UE) communicates. The method comprises the steps of: camping on a first cell on a first frequency; receiving a first threshold and a second threshold from a base station serving the first cell; determining whether a low mobility condition is satisfied on the basis of the first threshold; determining whether a not-in cell edge condition is satisfied on the basis of the second threshold; and determining whether to relax a measurement for a second frequency, on the basis of i) whether the first frequency belongs to FR1 or FR2, ii) whether the low mobility condition is satisfied, and iii) whether the not-in cell edge condition is satisfied, wherein on the basis of the first frequency belonging to the FR1.

### TECHNICAL FIELD

The present specification relates to mobile communications.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

When the UE performs measurement relaxation on the target cell in an area where the serving cell and the target cell overlap, a method for improving the system performance of the UE is required.

### SUMMARY

When the UE performs measurement relaxation, if the performance of the UE may decrease, the UE may perform measurement without performing measurement relaxation.

The present specification may have various effects.

For example, through the disclosure in the present specification, the UE can improve the system performance of the UE by increasing the chance of cell reselection.

Effects that can be obtained through specific examples of the present specification are not limited to the effects listed above. For example, various technical effects that a person having ordinary skill in the related art can understand or derive from the present specification may exist. Accordingly, the specific effects of the present specification are not limited to those explicitly described herein, and may include various effects that can be understood or derived from the technical characteristics of the present specification.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows an example of UE to which implementations of the present disclosure is applied.

FIG. 5 and FIG. 6 show a case in which two cell coverages overlap.

FIG. 7 shows a procedure of a UE according to the disclosure of the present specification.

FIG. 8 shows a procedure for the UE to perform measurement relaxation according to the disclosure of the present specification.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. Evolution of 3GPP LTE includes LTE-A (advanced), LTE-A Pro, and/or 5G NR (new radio).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

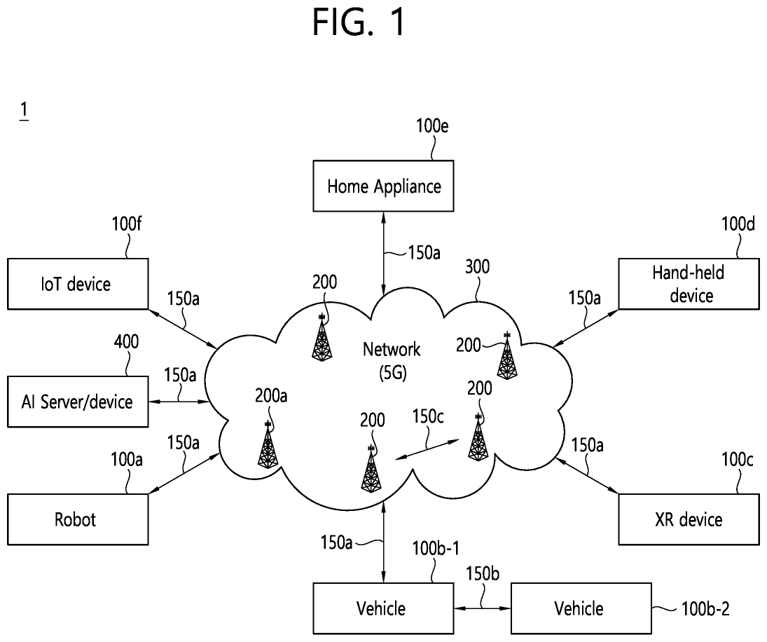

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

AI refers to the field of studying artificial intelligence or the methodology that can create it, and machine learning refers to the field of defining various problems addressed in the field of AI and the field of methodology to solve them. Machine learning is also defined as an algorithm that increases the performance of a task through steady experience on a task.

Robot means a machine that automatically processes or operates a given task by its own ability. In particular, robots with the ability to recognize the environment and make self-determination to perform actions can be called intelligent robots. Robots can be classified as industrial, medical, home, military, etc., depending on the purpose or area of use. The robot can perform a variety of physical operations, such as moving the robot joints with actuators or motors. The movable robot also includes wheels, brakes, propellers, etc., on the drive, allowing it to drive on the ground or fly in the air.

Autonomous driving means a technology that drives on its own, and autonomous vehicles mean vehicles that drive without user's control or with minimal user's control. For example, autonomous driving may include maintaining lanes in motion, automatically adjusting speed such as adaptive cruise control, automatic driving along a set route, and automatically setting a route when a destination is set. The vehicle covers vehicles equipped with internal combustion engines, hybrid vehicles equipped with internal combustion engines and electric motors, and electric vehicles equipped with electric motors, and may include trains, motorcycles, etc., as well as cars. Autonomous vehicles can be seen as robots with autonomous driving functions.

Extended reality is collectively referred to as VR, AR, and MR. VR technology provides objects and backgrounds of real world only through computer graphic (CG) images. AR technology provides a virtual CG image on top of a real object image. MR technology is a CG technology that combines and combines virtual objects into the real world. MR technology is similar to AR technology in that they show real and virtual objects together. However, there is a difference in that in AR technology, virtual objects are used as complementary forms to real objects, while in MR technology, virtual objects and real objects are used as equal personalities.

NR supports multiples numerologies (and/or multiple subcarrier spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., FR1 and FR2. The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter wave (mmW).

TABLE 1

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

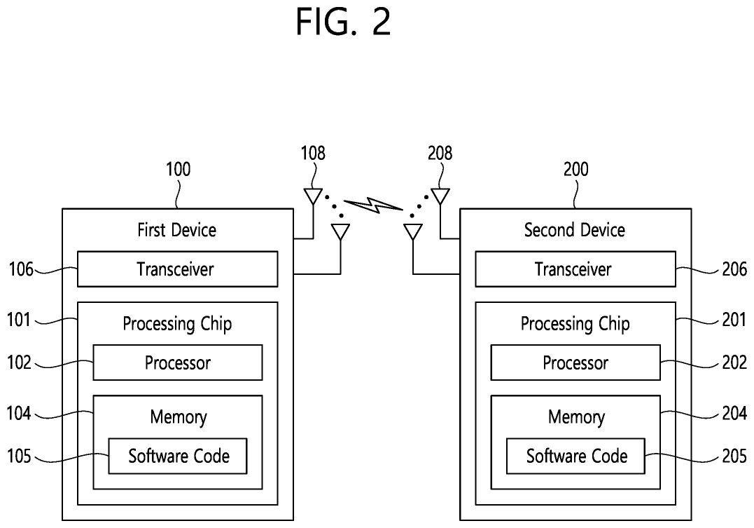

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR).

In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. It is exemplarily shown in FIG. 2 that the memory 104 is included in the processing chip 101. Additional and/or alternatively, the memory 104 may be placed outside of the processing chip 101.

The processor 102 may control the memory 104 and/or the transceiver 106 and may be configured to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with radio frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. It is exemplarily shown in FIG. 2 that the memory 204 is included in the processing chip 201. Additional and/or alternatively, the memory 204 may be placed outside of the processing chip 201.

The processor 202 may control the memory 204 and/or the transceiver 206 and may be configured to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

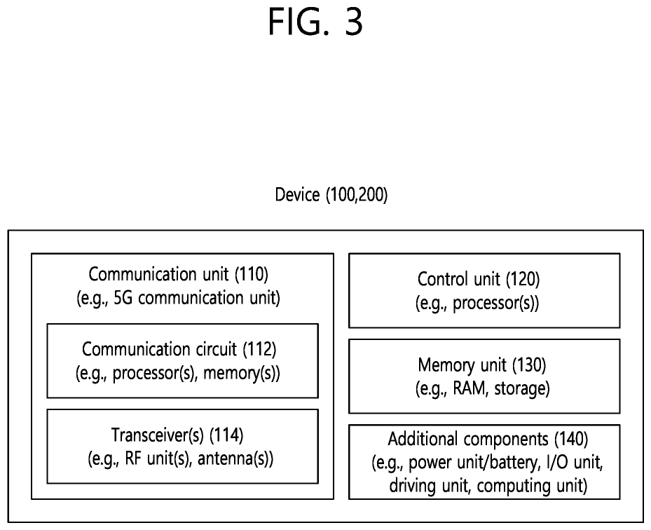

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory unit 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory unit 130 may be configured by a RAM, a DRAM, a ROM, a flash memory, a volatile memory, a non-volatile memory, and/or a combination thereof.

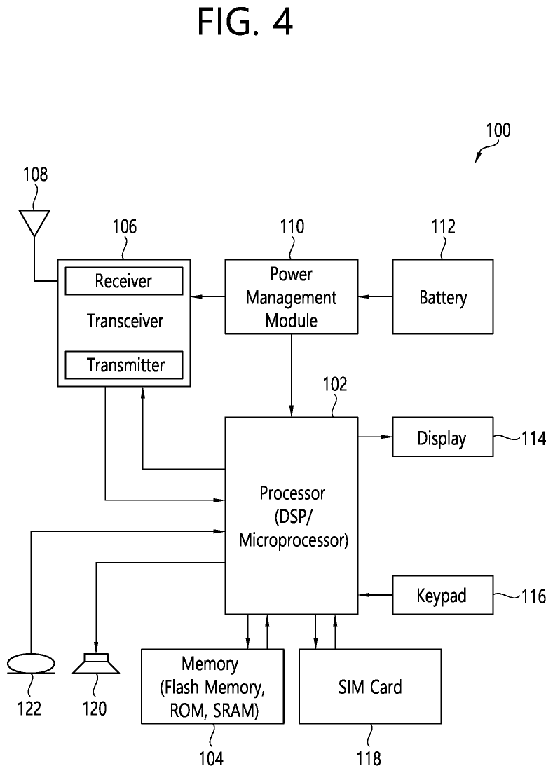

FIG. 4 shows an example of UE to which implementations of the present disclosure is applied.

Referring to FIG. 4, a UE 100 may correspond to the first wireless device 100 of FIG. 2 and/or the wireless device 100 or 200 of FIG. 3.

A UE 100 includes a processor 102, a memory 104, a transceiver 106, one or more antennas 108, a power management module 110, a battery 112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, a series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 116 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

<Cell Re-Selection>

The cell reselection procedure allows the UE to select a more suitable cell and camp on it.

When the UE is in either Camped Normally state or Camped on Any Cell state on a cell, the UE shall attempt to detect, synchronise, and monitor intra-frequency, inter-frequency and inter-RAT cells indicated by the serving cell. For intra-frequency and inter-frequency cells the serving cell may not provide explicit neighbour list but carrier frequency information and bandwidth information only. UE measurement activity is also controlled by measurement rules, allowing the UE to limit its measurement activity.

1. Requirements

1) UE Measurement Capability

For idle mode cell re-selection purposes, the UE shall be capable of monitoring at least:
Intra-frequency carrier, and
Depending on UE capability, 7 NR inter-frequency carriers, and
Depending on UE capability, 7 FDD E-UTRA inter-RAT carriers, and
Depending on UE capability, 7 TDD E-UTRA inter-RAT carriers.

In addition to the requirements defined above, a UE supporting E-UTRA measurements in RRC_IDLE state shall be capable of monitoring a total of at least 14 carrier frequency layers, which includes serving layer, comprising of any above defined combination of E-UTRA FDD, E-UTRA TDD and NR layers.

2) Measurement and Evaluation of Serving Cell

The UE shall measure the SS-RSRP and SS-RSRQ level of the serving cell and evaluate the cell selection criterion S for the serving cell at least once every M1*N1 DRX cycle; where:

M1=2 if SMTC periodicity (T_{SMTC})>20 ms and DRX cycle≤0.64 second,

Otherwise M1=1.

The UE shall filter the SS-RSRP and SS-RSRQ measurements of the serving cell using at least 2 measurements. Within the set of measurements used for the filtering, at least two measurements shall be spaced by, at least DRX cycle/2.

If the UE has evaluated according to Table 3 in Nₛₑᵣᵥ, consecutive DRX cycles that the serving cell does not fulfil the cell selection criterion S, the UE shall initiate the measurements of all neighbor cells indicated by the serving cell, regardless of the measurement rules currently limiting UE measurement activities.

If the UE in RRC_IDLE has not found any new suitable cell based on searches and measurements using the intra-frequency, inter-frequency and inter-RAT information indicated in the system information for 10 s, the UE shall initiate cell selection procedures for the selected PLMN.

TABLE 3

| | | |
|---|---|---|
| | | Nₛₑᵣᵥ |
| DRX cycle | Scaling Factor (N1) | [number of DRX |

| length [s] | FR1 | FR2^{Note1} | cycles] |
|---|---|---|---|
| 0.32 | 1 | 8 | M1*N1*4 |
| 0.64 | | 5 | M1*N1*4 |
| 1.28 | | 4 | N1*2 |
| 2.56 | | 3 | N1*2 |

^{Note1}:
Applies for UE supporting power class 2&3&4. For UE supporting power class 1, N1 = 8 for all DRX cycle length.

3) The UE shall be able to identify new intra-frequency cells and perform SS-RSRP and SS-RSRQ measurements of the identified intra-frequency cells without an explicit intra-frequency neighbour list containing physical layer cell identities.

The UE shall be able to evaluate whether a newly detectable intra-frequency cell meets the reselection criteria within T_{detect,NR_Intra} when that T_{reselection}=0. An intra frequency cell is considered to be detectable according to the conditions for a corresponding Band.

The UE shall measure SS-RSRP and SS-RSRQ at least every T_{measure,NR_Intra} (see table 4) for intra-frequency cells that are identified and measured according to the measurement rules.

The UE shall filter SS-RSRP and SS-RSRQ measurements of each measured intra-frequency cell using at least 2 measurements. Within the set of measurements used for the filtering, at least two measurements shall be spaced by at least T_{measure,NR_Intra}/2.

The UE shall not consider a NR neighbor cell in cell reselection, if it is indicated as not allowed in the measurement control system information of the serving cell.

For an intra-frequency cell that has been already detected, but that has not been reselected to, the filtering shall be such that the UE shall be capable of evaluating that the intra-frequency cell has met reselection criterion defined [1] within T_{evaluate,NR_Intra} when T_{reselection}=0 as specified in table 4 provided that:

when rangeToBestCell is not configured:
the cell is at least 3 dB better ranked in FR1 or 4.5 dB better ranked in FR2.

when rangeToBestCell is configured:
the cell has the highest number of beams above the threshold absThreshSS-BlocksConsolidation among all detected cells whose cell-ranking criterion R value [1] is within rangeToBestCell of the cell-ranking criterion R value of the highest ranked cell.
if there are multiple such cells, the cell has the highest rank among them.
the cell is at least 3 dB better ranked in FR1 or [4.5]dB better ranked in FR2 if the current serving cell is among them.

When evaluating cells for reselection, the SSB side conditions apply to both serving and non-serving intra-frequency cells.

If T_{reselection} timer has a non zero value and the intra-frequency cell is satisfied with the reselection criteria, the UE shall evaluate this intra-frequency cell for the T_{reselection} time. If this cell remains satisfied with the reselection criteria within this duration, then the UE shall reselect that cell.

TABLE 4

| DRX cycle | Scaling Factor (N1) | | T_{detect, NR}_{_{—}}_{Intra} [s] | T_{measure, NR}_{_{—}}_{Intra} [s] | T_{evaluate, NR}_{_{—}}_{Intra} [s] |
|---|---|---|---|---|---|
| length [s] | FR1 | FR2^{Note1} | (number of DRX cycles) | (number of DRX cycles) | (number of DRX cycles) |
| 0.32 | 1 | 8 | 11.52 * N1 * M2 | 1.28 * N1 * M2 | 5.12 * N1 * M2 |
| | | | (36 * N1 * M2) | (4 * N1 * M2) | (16 * N1 * M2) |
| 0.64 | | 5 | 17.92 * N1 (28 * N1) | 1.28 * N1 (2 * N1) | 5.12 * N1 (8 * N1) |
| 1.28 | | 4 | 32 * N1 (25 * N1) | 1.28 * N1 (1 * N1) | 6.4 * N1 (5 * N1) |
| 2.56 | | 3 | 58.88 * N1 (23 * N1) | 2.56 * N1 (1 * N1) | 7.68 * N1 (3 * N1) |

^{Note1}:
Applies for UE supporting power class 2&3&4. For UE supporting power class 1, N1 = 8 for all DRX cycle length.
Note 2:
M2 = 1.5 if SMTC periodicity of measured intra-frequency cell > 20 ms; otherwise M2 = 1.

4) Measurements of Inter-Frequency NR Cells

The UE shall be able to identify new inter-frequency cells and perform SS-RSRP or SS-RSRQ measurements of identified inter-frequency cells if carrier frequency information is provided by the serving cell, even if no explicit neighbor list with physical layer cell identities is provided.

If Sᵣₓₗₑᵥ>S_{nonIntraSearchP} and S_{qual}>S_{nonIntraSearchQ} then the UE shall search for inter-frequency layers of higher priority at least every T_{higher_priority_search} where T_{higher_priority_search} is described.

If Sᵣₓₗₑᵥ≤S_{nonIntraSearchP} or S_{qual}≤S_{nonIntraSearchQ} then the UE shall search for and measure inter-frequency layers of higher, equal or lower priority in preparation for possible reselection. In this scenario, the minimum rate at which the UE is required to search for and measure higher priority layers shall be the same as that defined below in this clause.

The UE shall be able to evaluate whether a newly detectable inter-frequency cell meets the reselection criteria defined in TS38.304 within K_{carrier}*T_{detect,NR_Inter} if at least carrier frequency information is provided for inter-frequency neighbor cells by the serving cells when T_{reselection}=0 provided that the reselection criteria is met by a margin of at least 5 dB in FR1 or 6.5 dB in FR2 for reselections based on ranking or 6 dB in FR1 or 7.5 dB in FR2 for SS-RSRP reselections based on absolute priorities or 4 dB in FR1 and 4 dB in FR2 for SS-RSRQ reselections based on absolute priorities. The parameter K_{carrier} is the number of NR inter-frequency carriers indicated by the serving cell. An inter-frequency cell is considered to be detectable according to the conditions for a corresponding Band.

When higher priority cells are found by the higher priority search, they shall be measured at least every T_{measure,NR_Inter}. If, after detecting a cell in a higher priority search, it is determined that reselection has not occurred then the UE is not required to continuously measure the detected cell to evaluate the ongoing possibility of reselection. However, the minimum measurement filtering requirements specified later in this clause shall still be met by the UE before it makes any determination that it may stop measuring the cell. If the UE detects on a NR carrier a cell whose physical identity is indicated as not allowed for that carrier in the measurement control system information of the serving cell, the UE is not required to perform measurements on that cell.

The UE shall measure SS-RSRP or SS-RSRQ at least every K_{carrier}*T_{measure,NR_Inter} (see table 5) for identified lower or equal priority inter-frequency cells. If the UE detects on a NR carrier a cell whose physical identity is indicated as not allowed for that carrier in the measurement control system information of the serving cell, the UE is not required to perform measurements on that cell.

The UE shall filter SS-RSRP or SS-RSRQ measurements of each measured higher, lower and equal priority inter-frequency cell using at least 2 measurements. Within the set of measurements used for the filtering, at least two measurements shall be spaced by at least T_{measure,NR_Inter}/2.

The UE shall not consider a NR neighbor cell in cell reselection, if it is indicated as not allowed in the measurement control system information of the serving cell.

For an inter-frequency cell that has been already detected, but that has not been reselected to, the filtering shall be such that the UE shall be capable of evaluating that the inter-frequency cell has met reselection criterion defined TS 38.304 within K_{carrier}*T_{evaluate,NR_Inter} when T_{reselection}=0 as specified in table 5 provided that the reselection criteria is met by
the condition when performing equal priority reselection and

when rangeToBestCell is not configured:
the cell is at least 5 dB better ranked in FR1 or 6.5 dB better ranked in FR2 or.

when rangeToBestCell is configured:
the cell has the highest number of beams above the threshold absThreshSS-BlocksConsolidation among all detected cells whose cell-ranking criterion R value [1] is within rangeToBestCell of the cell-ranking criterion R value of the highest ranked cell.
if there are multiple such cells, the cell has the highest rank among them
the cell is at least 5 dB better ranked in FR1 or [6.5]dB better ranked in FR2 if the current serving cell is among them. or
6 dB in FR1 or 7.5 dB in FR2 for SS-RSRP reselections based on absolute priorities or
4 dB in FR1 or 4 dB in FR2 for SS-RSRQ reselections based on absolute priorities.

When evaluating cells for reselection, the SSB side conditions apply to both serving and inter-frequency cells.

If T_{reselection} timer has a non zero value and the inter-frequency cell is satisfied with the reselection criteria, the UE shall evaluate this inter-frequency cell for the T_{reselection} time. If this cell remains satisfied with the reselection criteria within this duration, then the UE shall reselect that cell.

The UE is not expected to meet the measurement requirements for an inter-frequency carrier under DRX cycle=320 ms defined in Table 5 under the following conditions:
T_{SMTC_intra}=T_{SMTC_inter}=160 ms; where T_{SMTC_intra} and T_{SMTC_inter} are periodicities of the SMTC occasions configured for the intra-frequency carrier and the inter-frequency carrier respectively, and
SMTC occasions configured for the inter-frequency carrier occur up to 1 ms before the start or up to 1 ms after the end of the SMTC occasions configured for the intra-frequency carrier, and
SMTC occasions configured for the intra-frequency carrier and for the inter-frequency carrier occur up to 1 ms before the start or up to 1 ms after the end of the paging occasion [1].

TABLE 5

| DRX cycle | Scaling Factor (N1) | | T_{detect, NR}_{_{—}}_{Inter} [s] | T_{measure, NR}_{_{—}}_{Inter} [s] | T_{evaluate, NR}_{_{—}}_{Inter} [s] |
|---|---|---|---|---|---|
| length [s] | FR1 | FR2^{Note1} | (number of DRX cycles) | (number of DRX cycles) | (number of DRX cycles) |
| 0.32 | 1 | 8 | 11.52 * N1 * 1.5 | 1.28 * N1 * 1.5 | 5.12 * N1 * 1.5 |
| | | | (36 * N1 * 1.5) | (4 * N1 * 1.5) | (16 * N1 * 1.5) |
| 0.64 | | 5 | 17.92 * N1 (28 * N1) | 1.28 * N1 (2 * N1) | 5.12 * N1 (8 * N1) |
| 1.28 | | 4 | 32 * N1 (25 * N1) | 1.28 * N1 (1 * N1) | 6.4 * N1 (5 * N1) |
| 2.56 | | 3 | 58.88 * N1 (23 * N1) | 2.56 * N1 (1 * N1) | 7.68 * N1 (3 * N1) |

^{Note 1}:
Applies for UE supporting power class 2&3&4. For UE supporting power class 1, N1 = 8 for all DRX cycle length.

<Measurement Relaxation>

The UE may perform cell measurement according to a predetermined period in order to perform cell reselection. The reason for cell reselection is i) to select a cell faster for communication, or ii) to communicate through a new cell for communication when the UE is out of the coverage of the previously selected cell.

However, in RRC_IDLE and RRC_INACTIVE state moblility, when the UE is in a low mobility or not-in cell edge state, in order to save power of the UE, the UE may relax measurement for these cells. This is called measurement relaxation.

When the UE has low mobility, the UE has low mobility and is less likely to leave the coverage of the cell previously selected by the UE. In addition, when the location of the UE is not-in cell edge, since the UE is located at the center rather than the edge of the coverage of the previously selected cell, the possibility that the UE leaves the coverage of the previously selected cell is low. In this case, since there is a high possibility that the UE can perform communication through the previously selected cell for a certain period of time, the UE can relax the measurement of the cell other than the serving cell to save power of the UE.

There are two types of measurement relaxation methods: no measurement and longer interval. No measurement means that the UE does not perform measurement on a cell other than the serving cell for cell reselection, and longer interval means that the UE performs measurement with an interval longer than the normal case in which measurement relaxation is not performed.

An example of measurement relaxation is shown in Table 6.

TABLE 6

| Inter-frequency layer | | Higher priority | Higher/equal/lower priority | |
|---|---|---|---|---|
| The condition is fulfilled with | | Sᵣₓₗₑₓ > S_{nonIntraSearchP}, and | Sᵣₓₗₑₓ ≤ S_{nonIntraSearchP}, or | |
| | | S_{qual} > S_{nonIntraSearchQ} | S_{qual} ≤ S_{nonIntraSearchQ} | |
| power | (A) low mobility | no measurement | longer interval | longer interval |
| saving | (B) not-in cell edge | no measurement relaxation | longer interval | longer interval |
| | Both (A) and (B) | no measurement | no measurement | no measurement |

Sᵣₓₗₑᵥ refers to RSRP (Reference Signal Received Power) measured by the UE. S_{qual} refers to RSRQ (Reference Signal Received Quality) measured by the UE, and is a value obtained by dividing RSSI (Received Signal Strength Indication) by RSRP.

S_{nonIntraSearchP} is a threshold value of Sᵣₓₗₑᵥ for NR inter-frequency and inter-RAT measurement. S_{nonIntraSearchQ} is a threshold value of S_{qual} for NR inter-frequency and inter-RAT measurement.

Here, no measurement means that the UE does not perform measurement for a specific time at the point in time of the previous measurement. The specific time may be 1 hour.

Longer interval means that measurement is performed based on a longer measurement interval than a normal measurement interval. That is, the measurement is performed at a longer interval. Specific examples are shown in Table 7.

TABLE 7

| DRX cycle | Scaling Factor (N1) | | T_{detect, NR}_{_{—}}_{Inter} [s] | T_{measure, NR}_{_{—}}_{Inter} [s] | T_{evaluate, NR}_{_{—}}_{Inter} [s] |
|---|---|---|---|---|---|
| length [s] | FR1 | FR2^{Note1} | (number of DRX cycles) | (number of DRX cycles) | (number of DRX cycles) |
| 0.32 | 1 | 8 | 11.52(=36*0.32)*N1*1.5*L | 1.28*N1*1.5*L | 5.12*N1*1.5 *L |
| | | | (36*N1*1.5)*L | (4*N1*1.5)*L | (16*N1*1.5) *L |
| 0.64 | | 5 | 17.92*N1*L (28*N1)*L | 1.28*N1*L (2*N1)*L | 5.12*N1*L (8*N1)*L |
| 1.28 | | 4 | 32*N1*L (25*N1)*L | 1.28*N1*L (1*N1)*L | 6.4*N1*L (5*N1)*L |
| 2.56 | | 3 | 58.88*N1*L (23*N1)*L | 2.56*N1 (1*N1)*L | 7.68*N1*L (3*N1)*L |

^{Note1}:
Applies for UE supporting power class 2&3&4. For UE supporting power class 1, N1 = 8 for all DRX cycle length.
Note 2:
L is scaling value for measurement relaxation for power saving.

Table 7 becomes a longer interval by multiplying the interval of Table 5 by the scaling value L. L may be 2, 3 or 4. If measurement relaxation is not performed, the period may be set by setting the L value to 1, and when the measurement relaxation is performed, the period may be set by setting the L value to 3. No measurement relaxation means that UE performs the measurement as usual without measurement relaxation.

As shown in Table 6, when the low mobility condition is satisfied, the UE performs no measurement on a specific frequency layer having a high priority.

And if both the low mobility condition and the not-in cell edge condition are satisfied, no measurement is performed regardless of the priority of the frequency layer.

Even if the UE is not provided with explicit neighbor list including the physical layer cell identities, the UE can measure RSRP and RSRQ and find a cell of a new frequency.

If Sᵣₓₗₑᵥ is greater than S_{nonIntraSearchP} and S_{qual} is greater than S_{nonIntraSearchQ}, the UE may find a high-priority inter-frequency layer at least every T_{higher_priority_search} seconds.

If Sᵣₓₗₑᵥ is less than or equal to S_{nonIntraSearchP} and S_{qual} is less than or equal to S_{nonIntraSearchQ}, the UE may find an inter-frequency layer of higher, equal, or lower priority. In this case, the minimum period for the UE to search for the high priority layer is shown in Table 7. The UE may evaluate whether the newly detected inter-frequency cell satisfies the reselection criterion, within K_{carrier}*T_{detect, NR_Inter}.

<Problems to be Solved in the Disclosure of this Specification>

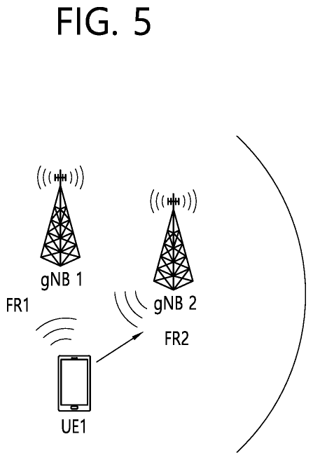

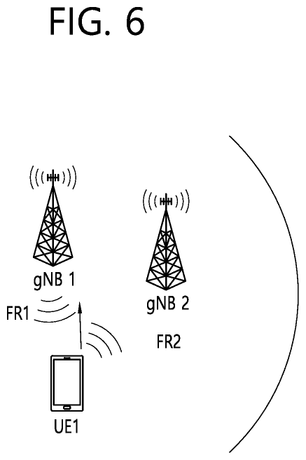

FIG. 5 and FIG. 6 show a case in which two cell coverages overlap.

FIG. 5 is a case in which the UE camps on the FR1 cell, and FIG. 6 is a case in which the UE camps on the FR2 cell.

When the UE satisfies both the low mobility condition and the not-in cell edge condition, the UE may not perform measurement until 1 hour has elapsed after performing the measurement for cell reselection (no measurement).

No measurement means that the UE does not perform intra/inter-frequency and inter-RAT measurements. Longer interval means that the UE performs intra/inter-frequency and inter-RAT measurements at a longer interval (four times as long as the normal interval) fixed by a scaling value to the normal interval. No measurement relaxation means that the UE performs intra/inter-frequency and inter-RAT measurements at regular intervals.

If only the FR1 cell is allocated to the UE, the UE performance issue may not exist. When the UE is located in a position where the FR1 cell and the FR2 cell overlap, the UE performance due to measurement relaxation may be affected depending on which cell the serving cell is (FR1 cell or FR2 cell).

FR1 cell and FR2 cell may coexist. In particular, FR2 may be allocated within FR1 network coverage as a hotspot.

When the UE camps on the FR1 cell and satisfies the low mobility condition and not-in cell edge condition, the UE may not perform measurement until 1 hour has elapsed after performing the measurement for cell reselection (no measurement). Then the UE may not have a chance to reselect the FR2 cell that provides a higher data rate. Even if the UE performs handover to the FR2 cell after the connected mode, handover delay and interruption time may occur. And even if the priority for the FR2 cell frequency is set high, the UE may not be able to measure the FR2 cell frequency layer. Therefore, system performance may be lowered.

When the UE camps on the FR2 cell and satisfies the low mobility condition and the not-in cell edge condition, the UE may not perform measurement until 1 hour has elapsed after performing the measurement for cell reselection (no measurement). In general, since the coverage of the FR2 cell is much narrower than the coverage of the FR1 cell, even if the UE has low mobility, the UE may deviate from the coverage of the FR2. In addition, there may be potential causes affecting the movement of the UE.

At this time, when the UE leaves the FR2 cell, if one hour has not passed since the UE performs the measurement, the UE may not measure any frequency layer. Due to this, the UE may not get an opportunity to reselect another cell, and thus the UE's performance may be lowered.

### DISCLOSURE OF THE PRESENT SPECIFICATION

The disclosures described below in this specification may be implemented in one or more combinations (e.g., a combination including at least one of the contents described below). Each of the drawings shows an embodiment of each disclosure, but the embodiments of the drawings may be implemented in combination with each other.

The description of the method proposed in the disclosure of the present specification may consist of a combination of one or more operations/configurations/steps described below. The following methods described below may be performed or used in combination or complementary.

It has been prepared to describe a specific example of the present specification. The names of specific devices described in the drawings or the names of specific signals/messages/fields are presented by way of example, so that the technical features of the present specification are not limited to the specific names used in the following drawings.

The following drawings were created to explain a specific example of the present specification. The names of specific devices described in the drawings or the names of specific signals/messages/fields are presented by way of example, so that the technical features of the present specification are not limited to the specific names used in the following drawings.

This specification proposes implementation in a situation where the FR1 cell and the FR2 cell coexist. These contents can also be applied to other intra-frequency and inter-RAT measurements.

The network may transmit information on measurement relaxation to the UE to configure information on measurement relaxation.

As an example of information on measurement relaxation, the network may set lowMobilityEvaluation to the UE to evaluate the low mobility condition. lowMobilityEvaluation may include at least one of s-SearchDeltaP and t-SearchDeltaP.

s-SearchDeltaP[dB] may be a threshold according to Sᵣₓₗₑᵥ change in applying measurement relaxation. t-SearchDeltaP[sec] may be a time unit for Sᵣₓₗₑᵥ change evaluated for measurement relaxation. That is, the Sᵣₓₗₑᵥ change value [dB] is measured for a time of t-SearchDeltaP[sec] and compared with s-SearchDeltaP[dB]. Sᵣₓₗₑᵥ refers to RSRP (Reference Signal Received Power) measured by the UE. s-SearchDeltaP may be one of 3, 6, 9, 12, 15 [dB], and t-SearchDeltaP may be one of 5, 10, 20, 30, 60, 120, 180, 240, 300 [sec].

For example, when s-SearchDeltaP is 3 dB and t-SearchDeltaP is 5 sec, if the change value of Sᵣₓₗₑᵥ for 5 seconds is less than 3 dB, the UE satisfies the low mobility condition.

As an example of information on measurement relaxation, the network may set cellEdgeEvaluation to the UE to evaluate a not-in cell edge condition. cellEdgeEvaluation may include at least one of s-SearchThresholdP and s-searchThresholdQ.

s-SearchThresholdP[dB] may be a threshold value for Sᵣₓₗₑᵥ and s-searchThresholdQ[dB] may be a threshold value for S_{qual}. S_{qual} refers to RSRQ (Reference Signal Received Quality) measured by the UE, and is a value obtained by dividing Received Signal Strength Indication (RSSI) by RSRP.

For example, if Sᵣₓₗₑᵥ is greater than s-SearchThresholdP and S_{qual} is greater than s-searchThresholdQ, the UE satisfies the not-in cell edge condition.

1. First Disclosure

The network may configure the UE by transmitting information on measurement relaxation to the UE, and the information may include priority information for a specific frequency layer.

A higher priority may be configured for the frequency of the FR2 cell. Then, the UE may not perform measurement relaxation on the frequency of the FR2 cell regardless of low mobility and not-in cell edge conditions (no measurement relaxation). That is, regardless of whether the UE satisfies the low mobility condition and the not-in cell edge condition, the measurement for the FR2 cell may be performed as usual. Therefore, even when the UE camps on the FR1 cell at a location where the FR2 cell and the FR1 cell coexist, the UE may reselect the FR2 cell by performing a measurement on the FR2 cell. More data can be transmitted and received through the FR2 cell, so that the performance of the UE may be improved.

A higher priority may be set for the frequency of the FR1 cell. Then, the UE may not perform measurement relaxation on the frequency of the FR1 cell regardless of low mobility and not-in cell edge conditions (no measurement relaxation). That is, regardless of whether the UE satisfies the low mobility condition and the not-in cell edge condition, the measurement for the FR1 cell may be performed as usual. Therefore, even when the UE camps on the FR2 cell at a location where the FR2 cell and the FR1 cell coexist, the UE may reselect the FR1 cell by performing a measurement on the FR1 cell. Since the measurement relaxation for the FR1 cell is not applied even in a situation where UE is out of the coverage of the FR2 cell, the UE may reselect the FR1 cell and communicate sooner than when the measurement relaxation is applied.

2. Second Disclosure

The network may configure the UE by transmitting information on measurement relaxation to the UE, but the information may not include priority information for a specific frequency layer. That is, the priority for the frequency of a specific cell may not be configured.

The network may configure the measurement relaxation method by setting the information on the measurement relaxation to the UE.

When the UE is in a position where the coverage of the FR1 cell and the FR2 cell overlap, the case where the UE camps on the FR1 cell and the case where the UE camps on the FR2 cell are divided and described later.

1) When the UE camps on the FR1 cell and the network does not set a high priority on the frequency of the FR2 cell

When the UE is set a low mobility condition or a not-in cell edge condition by the network, and the UE meets only one of the low mobility condition and the not-in cell edge condition, the UE may apply a longer interval. Alternatively, the UE may not apply measurement relaxation.

When a low mobility condition or a not-in cell edge condition is set for the UE by the network, and the UE satisfies both the low mobility condition and the not-in cell edge condition, the UE may not apply measurement relaxation.

Therefore, the UE may perform communication by reselecting the FR2 cell by performing a measurement on the FR2 cell in a state that camps on the FR1 cell.

2) When the UE camps on the FR2 cell and the network does not set a high priority to a specific frequency layer

When a low mobility condition or a not-in cell edge condition is set in the UE by the network, and the UE meets only one of the low mobility condition and the not-in cell edge condition, the UE may apply a longer interval. Alternatively, the UE may not apply measurement relaxation.

When a low mobility condition or a not-in cell edge condition is set for the UE by the network, and the UE satisfies both the low mobility condition and the not-in cell edge condition, the UE may not apply measurement relaxation.

Therefore, the UE may perform communication by reselecting the FR1 cell by performing a measurement on the FR1 cell in a state that camps on the FR2 cell.

3. Third Disclosure

The UE may apply measurement relaxation when a certain condition is satisfied. No measurement is one example of measurement relaxation as not performing measurement until a specific time has passed from the point in time when measurement was previously performed. The specific time may be 1 hour.

The network may configure the UE by transmitting information on measurement relaxation to the UE, and the information may include the above-described information on the specific time.

The network may set the specific time to be less than 1 hour and set it to the UE.

When a certain condition is satisfied and no measurement is performed for measurement relaxation, the UE may perform the measurement after a specific time set by the network. Even in a situation in which no measurement is applied, the UE may perform measurement after a time shorter than the conventional one hour from the point in time when the measurement was previously performed. Performance may be improved by allowing the UE to measure frequently.

The first disclosure, the second disclosure, and the third disclosure may be implemented independently as well as in combination.

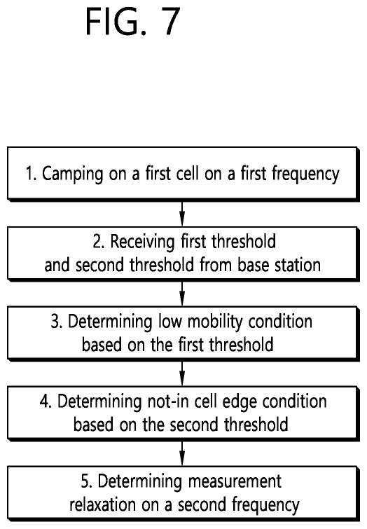

FIG. 7 shows a procedure of a UE according to the disclosure of the present specification.

1. The UE may camp on a first cell on a first frequency.

The first cell may be an FR1 cell or an FR2 cell. That is, the first frequency may belong to FR1 and may belong to FR2.

2. The UE may receive, from a base station serving the first cell, a first threshold value and a second threshold value.

The first threshold value may be a reference value for determining whether a low mobility condition is satisfied.

The first threshold value may be a value for s-SearchDeltaP and t-SearchDeltaP as the aforementioned lowMobilityEvaluation.

The second threshold may be a reference value for determining whether a not-in cell edge condition is satisfied.

The second threshold may be a value for s-SearchThresholdP and s-searchThresholdQ as the aforementioned cellEdgeEvaluation.

3. The UE may determine whether low mobility condition is satisfied, based on the first threshold value.

The method of determining whether the condition is satisfied is replaced by the above description.

4. The UE may determine whether not-in cell edge condition is satisfied, based on the second threshold value

The method of determining whether the condition is satisfied is replaced by the above description.

5. Based on the frequency priority information and whether the conditions determined in steps 3 and 4 are satisfied, the UE may perform measurement relaxation for the second frequency.

If the first frequency belongs to FR1, the second frequency may belong to the FR2. If the first frequency belongs to FR2, the second frequency may belong to FR1.

The execution method will be described with reference to FIG. 7.

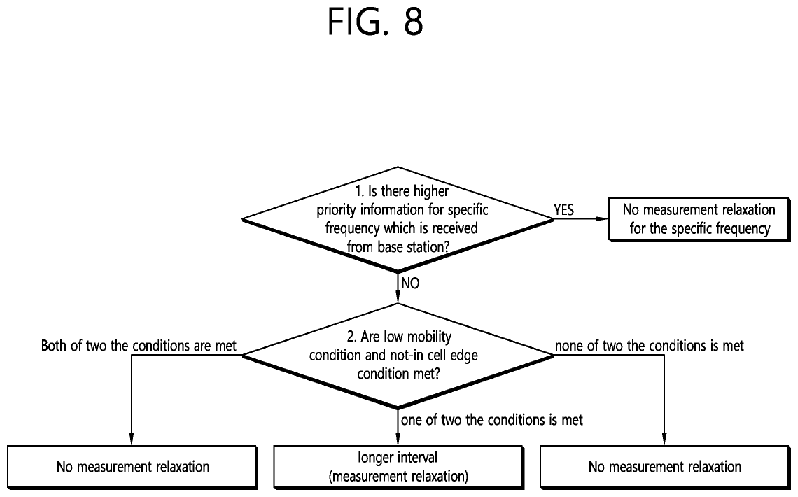

FIG. 8 shows a procedure for the UE to perform measurement relaxation according to the disclosure of the present specification.

1. If there is information that there is a higher priority for a specific frequency (the frequency of the FR1 cell or the frequency of the FR2 cell), measurement relaxation for the specific frequency may not be performed (no measurement relaxation).

If there is no information that there is a higher priority for a specific frequency (the frequency of the FR1 cell or the frequency of the FR2 cell), proceed to step 2 to be described later.

2. When neither of the low mobility condition nor the not-in cell edge condition is satisfied, measurement relaxation may not be performed (no measurement relaxation) because the measurement relaxation condition is not met.

When only one of the low mobility condition and the not-in cell edge condition is satisfied, longer interval measurement relaxation may be performed.

When both of the low mobility condition and the not-in cell edge condition are satisfied, no measurement relaxation is performed in the prior art, but in the present specification, measurement relaxation may not be performed (no measurement relaxation).

The present specification may have various effects.

For example, through the disclosure in the present specification, the UE can improve the system performance of the UE by increasing the chance of cell reselection.

Effects that can be obtained through specific examples of the present specification are not limited to the effects listed above. For example, various technical effects that a person having ordinary skill in the related art can understand or derive from the present specification may exist. Accordingly, the specific effects of the present specification are not limited to those explicitly described herein, and may include various effects that can be understood or derived from the technical characteristics of the present specification.

The claims described herein may be combined in various ways. For example, the technical features of the method claims of the present specification may be combined and implemented as an apparatus, and the technical features of the apparatus claims of the present specification may be combined and implemented as a method. In addition, the technical features of the method claim of the present specification and the technical features of the apparatus claim may be combined to be implemented as an apparatus, and the technical features of the method claim of the present specification and the technical features of the apparatus claim may be combined and implemented as a method. Other implementations are within the scope of the following claims.

1. A method for performing communication, performed by a UE (User Equipment), comprising:
camping on a first cell on a first frequency;
receiving, from a base station serving the first cell, a first threshold value and a second threshold value;
determining whether low mobility condition is satisfied, based on the first threshold value;
determining whether not-in cell edge condition is satisfied, based on the second threshold value;
determining whether measurement for a second frequency is relaxed, based on i) whether the first frequency belongs to FR1 or FR2, ii) whether the low mobility condition is satisfied and iii) whether the not-in cell edge condition is satisfied,
wherein the second frequency belongs to the FR2, based on the first frequency belonging to the FR1,
wherein the second frequency belongs to the FR1, based on the first frequency belonging to the FR2.

2. The method of claim 1,
wherein the step of determining whether measurement for the second frequency is relaxed is:
determining that measurement for the second frequency is not relaxed, based on i) the first frequency belonging to the FR1, ii) the low mobility condition being satisfied and iii) the not-in cell edge condition is satisfied.

3. The method of claim 1,
wherein the step of determining whether measurement for the second frequency is relaxed is:
determining that measurement for the second frequency is not relaxed, based on i) the first frequency belonging to the FR2, ii) the low mobility condition being satisfied and iii) the not-in cell edge condition is satisfied.

4. The method of claim 1, further comprising:
receiving, from the base station, frequency priority information,
wherein the frequency priority information is priority about the first frequency and the second frequency,
wherein the step of determining whether measurement for the second frequency is relaxed is:
determining that measurement for the second frequency is not relaxed, based on the frequency priority information being higher priority on the second frequency.

5. A UE (User Equipment) to perform communication, comprising:
a transceiver; and
a processor,
wherein the processor camps on a first cell on a first frequency;
wherein the transceiver receives, from a base station serving the first cell, a first threshold value and a second threshold value;
wherein the processor determines whether low mobility condition is satisfied, based on the first threshold value;
wherein the processor determines whether not-in cell edge condition is satisfied, based on the second threshold value;
wherein the processor determines whether measurement for a second frequency is relaxed, based on i) whether the first frequency belongs to FR1 or FR2, ii) whether the low mobility condition is satisfied and iii) whether the not-in cell edge condition is satisfied,
wherein the second frequency belongs to the FR2, based on the first frequency belonging to the FR1,
wherein the second frequency belongs to the FR1, based on the first frequency belonging to the FR2.

6. The UE of claim 5,
wherein the determining whether measurement for the second frequency is relaxed is:
determining that measurement for the second frequency is not relaxed, based on i) the first frequency belonging to the FR1, ii) the low mobility condition being satisfied and iii) the not-in cell edge condition is satisfied.

7. The UE of claim 5,
wherein the determining whether measurement for the second frequency is relaxed is:
determining that measurement for the second frequency is not relaxed, based on i) the first frequency belonging to the FR2, ii) the low mobility condition being satisfied and iii) the not-in cell edge condition is satisfied.

8. The UE of claim 5,
wherein transceiver receives, from the base station, frequency priority information,
wherein the frequency priority information is priority about the first frequency and the second frequency,
wherein the determining whether measurement for the second frequency is relaxed is:
determining that measurement for the second frequency is not relaxed, based on the frequency priority information being higher priority on the second frequency.

9. An apparatus in mobile communication, the apparatus comprising:
at least one processor; and
at least one memory storing instructions and operably electrically connectable with the at least one processor;
operation performed, based on the instructions being executed by the at least one processor, comprising:
camping on a first cell on a first frequency;
receiving, from a base station serving the first cell, a first threshold value and a second threshold value;
determining whether low mobility condition is satisfied, based on the first threshold value;
determining whether not-in cell edge condition is satisfied, based on the second threshold value;
determining whether measurement for a second frequency is relaxed, based on i) whether the first frequency belongs to FR1 or FR2, ii) whether the low mobility condition is satisfied and iii) whether the not-in cell edge condition is satisfied,
wherein the second frequency belongs to the FR2, based on the first frequency belonging to the FR1,
wherein the second frequency belongs to the FR1, based on the first frequency belonging to the FR2.

10. (canceled)
